(19) United States
(12) Patent Application Publication
(10) Pub. No.: US 2015/0169701 A1
(43) Pub. Date: Jun. 18, 2015

(54) PROVIDING CUSTOMIZED CONTENT IN KNOWLEDGE PANELS

(71) Applicant: Google Inc., (US)

(72) Inventors: Zoltan Stekkelpak, Sunnyvale, CA (US); Gyula Simonyi, Dublin (IE)

(73) Assignee: Google Inc., Mountain View, CA (US)

(21) Appl. No.: 13/750,354

(22) Filed: Jan. 25, 2013

(51) Int. Cl. G06F 17/30

(52) U.S. Cl. CPC G06F 17/30554

(57) ABSTRACT

Methods, systems, and apparatus for providing customized content in knowledge panels. In one aspect, a method includes receiving input from a user device; identifying, based on historical data describing user interactions for the user device, a topic of interest; identifying an entity responsive to the input; identifying eligible content items that are eligible for presentation in a knowledge panel that is to be presented with results responsive to the input, wherein at least one eligible content item is obtained from a first resource and at least one second eligible content item is obtained from a second resource; ranking the eligible content items based, in part, on the topic of interest; selecting one or more of the eligible content items based on the rankings; and providing, to the user device, data that causes each selected eligible content item to be presented in the knowledge panel in response to the input.

### BACKGROUND

This specification relates to presenting data in a knowledge panel.

The Internet provides access to a wide variety of resources, such as image files, audio files, video files, and web pages. A search system can identify resources in response to queries submitted by users and provide information about the resources in a manner that is useful to the users. The users then navigate through (e.g., click on) the search results to acquire information of interest to the users.

Users of search systems are often searching for information regarding a specific entity. For example, users may want to learn about a city that they are visiting. Conventionally, the users would initiate searches for the city and select from lists of search results determined to be relevant to the city.

### SUMMARY

This specification describes technologies relating to providing customized content in knowledge panels.

In general, one innovative aspect of the subject matter described in this specification can be embodied in methods that include the actions of receiving input from a user device; identifying, based on historical data describing user interactions for the user device, a topic of interest associated with a user of the user device; identifying an entity responsive to the input; identifying a plurality of eligible content items that are eligible for presentation in a knowledge panel that is to be presented with results responsive to the input, wherein at least one eligible content item is obtained from a first resource and at least one second eligible content item is obtained from a second resource; ranking the eligible content items based, in part, on the topic of interest; selecting one or more of the eligible content items based on the rankings; and providing, to the user device, data that causes each selected eligible content item to be presented in the knowledge panel in response to the input. Other embodiments of this aspect include corresponding systems, apparatus, and computer programs, configured to perform the actions of the methods, encoded on computer storage devices.

These and other embodiments can each optionally include one or more of the following features. Identifying a topic of interested associated with the user of the user device may comprise identifying a topic of interest that is explicitly selected by the user as a topic of interest.

Ranking the eligible content items based, in part, on the topic of interest may comprise: determining, based on implicit user indications identified in the historical data, an interest score that indicates a strength of the user's interest in the topic of interest relative to a strength of the user's interest in a different topic; determining, based on explicit user indications identified in the historical data, a confidence score that indicates a confidence that the user is interested in the identified topic of interest; determining, for each eligible content item, a resource score that indicates an importance of content included in the eligible content item with respect to a resource from which the eligible content item was obtained; and ranking the eligible content items based on the interest score, confidence score, and resource scores.

The method may further comprise determining that a proper subset of content included in a particular selected eligible content item corresponds to the topic of interest, and wherein, in response to the determination, providing data that causes each selected eligible content item to be presented in the knowledge panel includes providing data that causes the proper subset of content to be distinguished from other content included in the particular selected eligible content item when presented in the knowledge panel.

The method may further comprise: receiving, from the user device, user input indicating selection of one of the content items presented in the knowledge panel, and in response: providing, to the user device, data that causes presentation of a resource from which the selected content item was obtained. In addition, the input may be a search query.

Particular embodiments of the subject matter described in this specification can be implemented so as to realize one or more of the following advantages. A knowledge panel provided with search results displays information customized based on the user. The customized information displayed in a knowledge panel may satisfy the user's search needs without requiring the user to browse through search results. The information displayed is customized to the searching user device, which may also help satisfy the user's informational need. For example, a user is provided with information relevant to the entity the user was searching for, as well as information that is particularly of interest to the user. By presenting connections between the displayed information and what a user may already know, the displayed information puts the content into a user-specific context, facilitating user internalization of new information. In addition, a user may discover or learn information that is of interest without having actively searched for the specific information, improving the user's search, learning, and information discovery experience.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which customized content is provided in a knowledge panel.

FIG. 2 is a block diagram of an example data flow in which customized content is provided in a knowledge panel.

FIG. 3A is an example screen shot of a user interface in which customized content is provided in a knowledge panel.

FIG. 3B is another example screen shot of a user interface in which customized content is provided in a knowledge panel.

FIG. 4 is a flow diagram of an example process for providing customized content in a knowledge panel.

FIG. 5 is a block diagram of an example data processing apparatus.

Like reference numbers and designations in the various drawings indicate like elements.

### DETAILED DESCRIPTION

A search engine provides a knowledge panel in response to receiving a search query. A knowledge panel is a user interface element that provides information or other content related to a particular entity determined to be relevant to the search query. Example entities include a person, place, country, landmark, animal, historical event, organization, business, sports team, sporting event, movie, song, album, game, and work of art. The content provided in the knowledge panel may be selected based on one or more topics of interest associated with the user device that issues the search query.

The search engine receives the query from the user device and identifies a topic of interest associated with the user of the device based on historical data. For example, the user may issue the search query “Atlanta” to the search engine, and based on an interest determined for the user of the user device, the search engine identifies “baseball” as a topic of interest. The search query, “Atlanta,” is identified by the search engine as a factual entity—e.g., a city—and the search engine obtains a knowledge panel that corresponds to Atlanta.

The search engine identifies content items that are eligible for presentation in the knowledge panel. Content items may be, for example, snippets of content obtained from resources available over a network. Example resources include travel websites, news articles, images, informational pages, and other resources relevant to the factual entity that corresponds to the knowledge panel—e.g., Atlanta. Content items that are eligible for presentation are ranked based on the identified topic of interest—e.g., “baseball.” Thus, content items obtained from resources related to baseball have their ranking increased relative to content items that are unrelated to baseball.

The search engine selects one or more eligible content items based on their rankings and causes the content items to be displayed in a knowledge panel on the user device. For example, the search engine may select an image of Atlanta's skyline, the weather forecast for Atlanta, and news related to Atlanta's professional baseball team for display in the knowledge panel for Atlanta. Accordingly, in this example the user is presented with a knowledge panel that includes information related to the search query, “Atlanta,” as well as information related to the user's interest in baseball.

The systems and methods described herein generally relate to a search engine providing knowledge panels in response to a search query. However, knowledge panels may also be provided by non-traditional search engines, such as information discovery engines that do not require a search query input. In some implementations, knowledge panels may be provided without requiring explicit user input. For example, knowledge panels may be provided to a user device, e.g., “pushed,” based on artificial intelligence predictions of informational need based on, for example, a date, time, and/or location of the user device and historical interactions with the user device and/or historical interactions of other user devices at a similar date, time, and/or location.

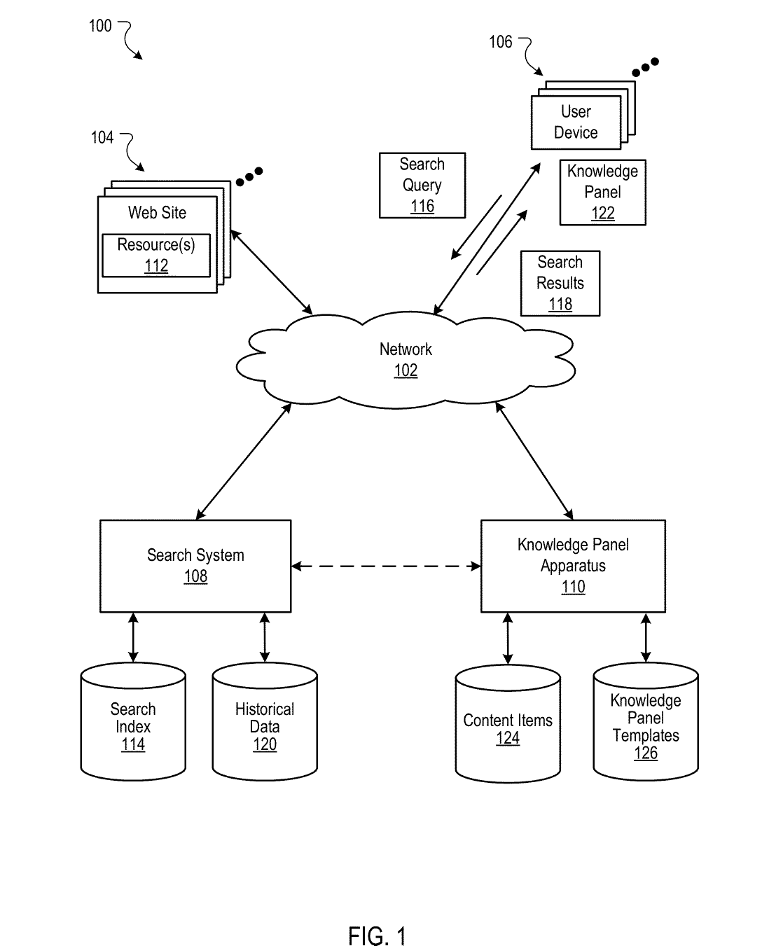

FIG. 1 is a block diagram of an example environment 100 in which customized content is provided in a knowledge panel. The example environment 100 includes a network 102, e.g., a local area network (LAN), wide area network (WAN), the Internet, or a combination of them, which connects web sites 104, user devices 106, the search system 108, and the knowledge panel apparatus 110. The network 102 can be accessed over a wired and/or a wireless communications link. For example, mobile computing devices, such as smartphones, can utilize a cellular network to access the network. The environment 100 may include millions of web sites 104 and user devices 106.

A web site 104 is one or more resources 112 associated with a domain name and hosted by one or more servers. An example web site is a collection of web pages formatted in hypertext markup language (HTML) that can contain text, images, multimedia content, and programming elements, e.g., scripts. Each web site 104 is maintained by a publisher, e.g., an entity that manages and/or owns the web site.

A resource 112 is data provided over the network 102 and that is associated with a resource address, e.g., a uniform resource locator. Resources 112 that can be provided by a web site 104 include HTML pages, word processing documents, and portable document format (PDF) documents, images, video, and feed sources, to name just a few. The resources 112 can include content, e.g., words, phrases, images and sounds and may include embedded information, e.g., meta information and hyperlinks, and/or embedded instructions, e.g., scripts.

A user device 106 is an electronic device that is under control of a user and is capable of requesting and receiving resources 112 over the network 102. Example user devices 106 include personal computers, mobile computing devices, e.g., smartphones and/or tablet computing devices, which can send and receive data over the network 102. A user device 106 typically includes a user application, e.g., a web browser, to facilitate the sending and receiving of data over the network 102.

To facilitate searching of resources 112, the search system 108 identifies the resources 112 by crawling and indexing the resources 112 provided on web sites 104. Data about the resources 112 can be indexed based on the resource to which the data corresponds. The indexed and, optionally, cached copies of the resources 112 are stored in a search index 114.

The user devices 106 submit search queries 116 to the search system 108. In response, the search system 108 accesses the search index 114 to identify resources 112 that are relevant to the search query, e.g., that are determined by the search system 108 to have at least a minimum specified relevance score for the search query 116. The search system 108 identifies the resources 112, generates search results 118 that identify the resources 112, and returns the search results 118 to the user devices 106. An example search result 118 is data generated by the search system 108 that identifies a resource 112 that is responsive to a particular search query, and includes a link to the resource 112. An example search result 118 can include a web page title, a snippet of text or a portion of an image extracted from the web page, and the URL of the web page.

Data for the search queries 116 submitted during user sessions are stored in a data store, such as the historical data store 120. For example, the search system 108 can store received search queries in the historical data store 120. Selection data specifying actions taken in response to search results 118 provided in response to each search query 116 may also be stored in the historical data store 120, for example, by the search system 108. These actions can include whether a search result 116 was selected (e.g., clicked or hovered over with a pointer), and topics or subjects of the resources identified by the search results.

The historical data store 120 also includes data describing user interactions for particular user devices. For example, a user may provide an explicit indication to the search system 108 that the user is interested in one or more topics, such as baseball, travel, or video games. The explicit indication may be, for example, a form filled out by the user and submitted to the search system 108. In some implementations, a user may provide an implicit indication to the search system 108 that the user is interested in one or more topics. An implicit indication may be, for example, a user's selection of a particular web page as a favorite web page, or the user's subscription to a Really Simple Syndication (RSS) feed of a particular website. Other implicit indications for a particular user may be, for example, topical interests of other users who are similar to the particular user, e.g., topical interests of users in the same location and of the same age and gender may be used as implicit indications to predict topics of interest to a user. These explicit and implicit indications may be stored in the historical data store 120 with a device identifier that identifies the user's user device.

In situations in which the systems discussed here collect personal information about users, or may make use of personal information, the users may be provided with an opportunity to control whether programs or features collect user information (e.g., information about a user's social network, social actions or activities, profession, a user's preferences, topics of interest, or current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The knowledge panel apparatus 110 is communicably coupled to the search system 108 (e.g., directly coupled or coupled over a network such as network 102). The search system 108 can interact with the knowledge panel apparatus 110 to determine whether to provide a knowledge panel 122 with search results 118 for a search query 116. If it is determined that a knowledge panel 122 should be provided, the knowledge panel apparatus 110 can generate the knowledge panel 122 and provide the generated knowledge panel 122 to the search system 108, which in turn provides search results 118 and a knowledge panel 122 to the user device 106 that submitted the search query 116.

While the search system 108 and knowledge panel apparatus 110 are depicted in the example environment 100 as separate systems, they may also be part of the same system or data processing apparatus. In some implementations, the knowledge panel apparatus 110 may provide a knowledge panel 122 to a user device 106, rather than providing the knowledge panel to the search system 108 first. In some implementations, the search system and/or knowledge panel apparatus only provides a knowledge panel 122 in response to the search query 116, without search results 118.

A knowledge panel 122 is typically provided for queries that have been determined to reference a particular entity, such as a person, place, country, landmark, animal, historical event, organization, business, sports team, sporting event, movie, song, album, game, or work of art. In general, a knowledge panel 122 for a particular entity includes content related to the particular entity. In some implementations, a knowledge panel 122 includes a set of factual information deemed relevant to the particular entity. For example, a knowledge panel 122 for an actor may include biographical information for the actor, as well as content associated with movies or television shows in which the actor has appeared. In some implementations, the knowledge panel 122 includes a summary of information related to the particular entity. For example, a knowledge panel 122 for a nation may include a map of the nation, the flag of the nation, the official language of the nation, and/or other facts and content related to the nation.

In some implementations where a knowledge panel 122 is provided with search results 118, a knowledge panel 122 is larger and consumes more area of a search interface than a standard search result 118. For example, the knowledge panel 122 may span the length of three or more standard search results 118 to accommodate the content items in the knowledge panel 122 and to draw attention to the knowledge panel 122.

In some implementations, a knowledge panel 122 is displayed in a knowledge panel area. The knowledge panel area may be presented with or alongside to a search results area that presents search results 118. In some implementations, the knowledge panel area consumes a larger area than the area consumed by two or more of the search results presented in the search results area.

The knowledge panel apparatus 110 includes or is communicably coupled to one or more data storage units that include a content items store 124 and a knowledge panel templates store 126. The content items store 124 stores content items that can be inserted into a knowledge panel. In general, the content items are discrete units of content and can be in the form of text, images, videos, graphics, audio, tables, or other types of content.

In some implementations, the content items store 124 includes an index of entities and data identifying content items relevant to the entities. For example, the index may include data identifying a title for an entity, one or more images relevant to the entity, a description of the entity, one or more facts about the entity, one or more videos relevant to the entity, upcoming events related to the entity, content from a social networking page associated with the entity, and other information or types or categories of content that have been deemed relevant to the entity.

The content items for each entity can come from disparate sources and/or disparate publishers. For example, content items for a particular entity can be obtained from several different web pages or other resources that are each hosted by different publishers. To illustrate, the content items for a particular actor may include images of the actor received from several different sources and these images can be included in the same knowledge panel that is provided in response to a query that references the particular actor. As another example, an image of a person may be obtained from an official site for the person, and a set of facts and/or description for the person may be obtained from an online encyclopedia.

In some implementations, the knowledge panel apparatus 110 identifies content items for each of a set of entities by crawling the Internet for content related to the entity. The knowledge panel apparatus 110 can also determine which of the obtained content items to provide with a knowledge panel 122 for the entity. For example, some of the content items may be more relevant to the entity or more appropriate for the knowledge panel 122 than other content items. As an example, an image of a person's face may be more appropriate for a knowledge panel 122 than an image of the person taken from a long distance.

The type or categories of content provided in a knowledge panel 122 may be determined based on the particular entity or the type of entity referenced by the knowledge panel 122. For example, a knowledge panel 122 for a person may include an image of the person, facts about the person, and references to any public works produced by the person. By way of another example, a knowledge panel 122 for a landmark may include images of the landmark, facts about the landmark, and travel information, such as a map, for a person to travel to the landmark. The categories of content that are included in a knowledge panel 122 can also vary based on the particular entity. For example, a person that has acted in movies and that has also recorded one or more albums may include references to both types of works. A knowledge panel template may specify the content for a knowledge panel 122, as described in more detail below.

The type or categories of content provided in a knowledge panel 122 may also be determined based on one or more topics of interest that correspond to the user device 106 issuing a search query 116. For example, “baseball” may be identified as a known topic of interest for a user device, based on data associated with the user device that is stored in the historical data 120. In response to receiving a query for a particular city, information related to the city's baseball team may be provided to the user device in a knowledge panel 122 for the city. If a different user has an interest in “art,” a knowledge panel for the same city may include a content item related to art museums and/or artists in or related to the city.

Although different types of content can be provided for different user devices and for different types of entities and/or different entities within an entity type, the knowledge panels can be configured to provide a recognizable and consistent user interface for users. In some implementations, each knowledge panel 122 can have one or more standard types of content items. For example, the standard types of content items can include a title, an image, a description, and one or more facts about the entity for which the knowledge panel 122 is provided.

In some implementations, the title for a knowledge panel 122 is the name of the entity or an alias of the entity. For example, the title for a knowledge panel 122 provided for a person can be the name of the person. Similarly, the title for a knowledge panel 122 provided for a country can be the name of the country. As the name of the entity may be different from the search query 116 for which the knowledge panel 122 is provided, the title may also be different than the search query 116. For example, a search query 116 may reference an alias or a shortened version of a celebrity's name, while the title for the knowledge panel 122 may include the celebrity's full legal name. In this way, the title provides confirmation of what the knowledge panel 122 references.

The description for the knowledge panel 122 can provide an adequate explanation of what the entity is, such as a summary of the entity, without going into so much detail to distract from the search interface (or other page) in which the knowledge panel 122 is presented. Candidate descriptions can be obtained from a variety of places, such as prefixes of text from trusted encyclopedia articles or top ranking web pages.

The image for a knowledge panel 122 can be an image representative of the entity for which the knowledge panel 122 is generated. This image may vary based on the type of entity and the entity itself. For example, an image for a country may include a map of the country, while an image for a person may include a representative image of the person.

The image for a knowledge panel 122 may be selected by taking a top ranking image from search results for the entity of the knowledge panel 122. For example, a web search directed to images can be performed for an entity and the top ranking image may be selected for the search results for inclusion in knowledge panels 122 for the entity.

The set of facts that are presented in a knowledge panel 122 may be determined based on the type of entity and/or the entity itself. For example, certain facts may be preferred for actors, and a different set of facts may be preferred for singers. Also, certain facts may be relevant to certain entities within an entity type, while not being relevant to other entities within the entity type. For example, a knowledge panel 122 for an actor that has won many awards may include a listing of the awards in the set of facts. However, a listing of awards may be omitted for an actor that has not yet won any awards.

The set of facts that are presented for a particular entity may be based on previously received search queries 116 that referenced the particular entity. For example, if a significant number, e.g., at least a threshold number, of previously received search queries 116 have referenced a person's height, then the person's height may be included in the set of facts that are presented in a knowledge panel for that person. In general, the facts for an entity can be ranked based on the number of the previously received search queries that have been deemed to be requesting information about the entity and that have been deemed to be requesting information about that fact.

The set of facts, images, or other content items that are presented for a particular entity may be based on user interactions described in historical data that corresponds to the user device that issued the search query for which the knowledge panel is being presented. For example, if a user has expressed an interest in a particular actor, a knowledge panel for a film that the actor appears in may indicate that the actor appears in the film. In some implementations, content that has been customized based on the user device can be distinguished from other facts, e.g., bold, underline, italic, highlighted and/or colored text. For example, if the knowledge panel for a film includes a list of actors, and the user device is associated with an interest in a particular actor included in the list, the actor's name may be highlighted in the list of actors.

Each of the standard types of content items, e.g., title, image, description, and facts, can consistently be located in a same portion of the knowledge panel 122 to provide a consistent user interface across knowledge panels for different types of entities. For example, an image may be located near the top left corner of the knowledge panel 122 and the description and facts may be located to the right of the image. If a content item for one of the types of content items is not available for an entity, then that type of content item may be replaced with another type of content item. For example, if an entity does not have an available image, one or more facts may be presented in the knowledge panel in place of an image. Note that the standard types of content items referenced throughout this document are provided above for purpose of example, and that other types of content items can be selected as standard content items.

The knowledge panel templates store 126 stores knowledge panel templates that can be populated with content items to generate a knowledge panel 122. In general, a knowledge panel template specifies types of content items to include in the knowledge panel 122 and includes placeholders for content items of the specified type. For example, a knowledge panel template may include placeholders for a title, one or more images, a description, a set of facts, and/or other types of content items.

The knowledge panel templates store 126 can include one or more templates for each of a set of entity types. For example, the knowledge panel templates store 126 may include one or more “person” templates, “place” templates, “landmark” templates, “movie” templates, “business” templates, “game” templates, “sports team” templates, “sports event” templates, and/or “disambiguation” templates. A knowledge panel template for a particular type of entity may have placeholders for different content item types than a knowledge panel template for another type of entity. For example, a knowledge panel template for a country may include a placeholder for a set of images of cities in the country, while a knowledge panel template for a landmark may include a placeholder for a set of images of other landmarks. Other types of content particular to a type of entity are described below.

The knowledge panel templates store 126 may also include knowledge panel templates for entity subtypes. For example, under the “person” entity type, there may be an “actor” knowledge panel template, a “singer” knowledge panel template, and/or a “historical figure” knowledge panel template. A knowledge panel template for actors may include a placeholder for a set of images of movie or television show posters for movies or television shows in which the actor performed, while a knowledge panel template for singers may include a placeholder for a table element having information regarding songs released by the singer.

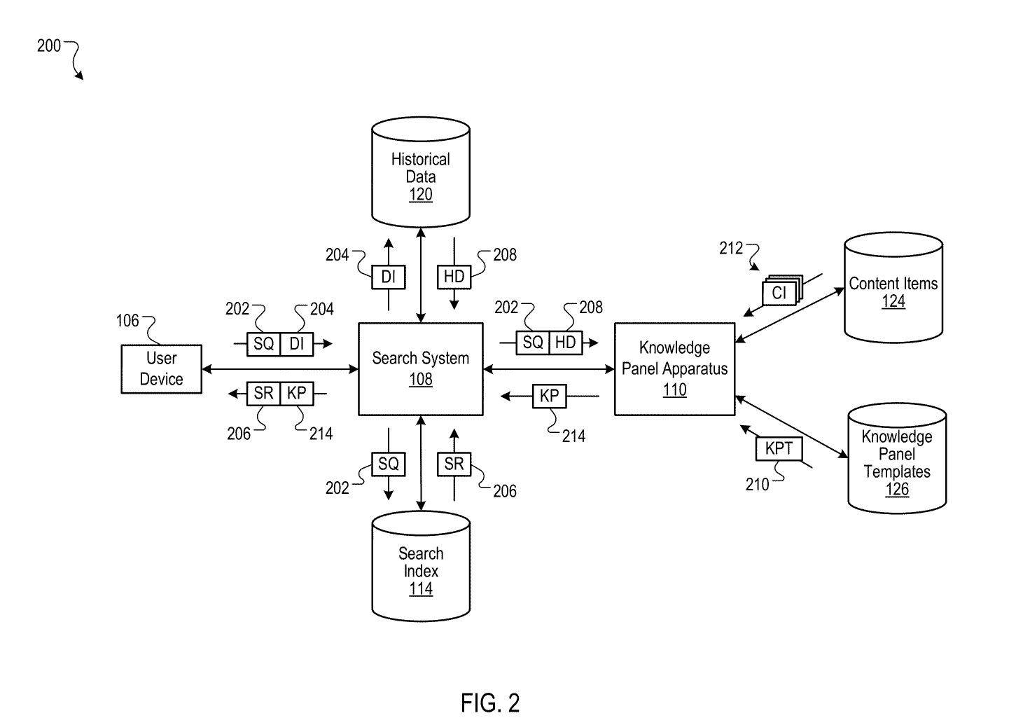

FIG. 2 is a block diagram of an example data flow 200 in which customized content is provided in a knowledge panel. In the example data flow 200, a user device 106 provides a search query 202 and a device identifier 204 to the search system 108. For example, the search query 202 may be “Atlanta.” In some implementations, the input provided by the user device may not be a search query. For example, the user device 106 may, without requiring user input, send the search system 108 data indicating a device identifier and a location of the user device, e.g., Atlanta, Ga., United States.

Upon receipt of the search query 202 and the device identifier 204, the search system 108 obtains search results 206 from the search index 114. For example, search results for “Atlanta” may include resources related to the city of Atlanta, Ga., such as a city government web page, a news article, an encyclopedia web page entry, and travel information for trips to Atlanta. The search system 108 also obtains historical data 208 from the historical data store 120. The historical data 208 includes data associated with the device identifier 204 of the user device 106. For example, the historical data 208 may include past search queries, browsing history, social network contacts, preferences, and/or topics of interest associated with the user device 106. In some implementations, as described above, some topics of interest are implicitly identified by the search system 108 based on the historical data.

In some implementations, no historical data 208 exists for a particular device identifier 204. For example, a user device that is using the search system 108 for the first time may not have any stored historical data. In this situation, the historical data includes data that has been provided by the user device in the current session. For example, a user device may provide, in addition to the search query 202, data indicating geographic location of the user device, an operating system of the user device, and a type of user device—e.g., a mobile device or a desktop computer. In addition, the search system 108 may be able to identify a language of the search query 202. This information may be the only historical data available to the search system 108.

In some implementations, historical data 208 may include user segment data that includes information based on one or more user device segments associated with the user device 106. A user segment defines a category for a user device and may be identified based on implicit or explicit indications provided by a user device. For example, one user segment may include user devices that are mobile devices using a particular operating system. Another user segment may include male users over the age of 40 that are in the United States. User segment data may include topics of interest that are likely to be of interest to users that belong to the user segment. Thus, if a user device is included in a particular user segment, the user segment, or interests associated with the particular user segment, may be included in historical data 208 for the user device.

The search system 108 provides the search query 202 and historical data 208 to the knowledge panel apparatus 110. In some implementations, the search query 202 may be disambiguated or altered before being provided to the knowledge panel apparatus 110. For example, spelling errors may be corrected and extraneous words or characters may be removed from the search query 202. In some implementations, the search system 108 identifies an entity that is responsive to the search query 202. For example, because more than one query can reference the same entity, the search system 108 may determine whether an entity is responsive to the search query by consulting an index of entities.

In some implementations, the search system 108 provides an entity derived from the search query 202 to the knowledge panel apparatus 110, as opposed to providing the original search query 202. For example, queries, such as “city of Atlanta,” “Atlanta, Ga.,” “Atlanta,” or “capital of Georgia” may be received by the search system 108 and reduced to a single query or entity, such as “Atlanta,” before being provided to the knowledge panel apparatus 110.

The knowledge panel apparatus 110 obtains a knowledge panel template 210 from the knowledge panel templates data store 126 and content items 212 from the content items data store 124. The knowledge panel template 210 defines one or more layouts for a knowledge panel. For example, the knowledge panel template 210 obtained for the entity, “Atlanta,” may be a template for United States cities. The knowledge panel template 210 may specify, for example, that portions of the knowledge panel are reserved for specific types of content, such as images, maps, future events, points of interest, geographic information, demographic information, or weather information, just to name a few.

Each content item 212 includes a snippet of content, such as an image, a video, an interactive web object, or text. In some implementations, the content items 212 have been obtained from network resources and indexed in the content items data store 124 according to their corresponding entity. For example, the content items data store 124 may include content items 212 that correspond to the city of Atlanta. The type and number of content items stored for any given entity may vary, and any given entity may have, for example, a few, dozens, hundreds, or thousands of content items. Example content items for the city of Atlanta may include a map of Atlanta, images of landmarks, and snippets of text and/or images specifying tourist destinations, points of interest, upcoming events, geographic facts, local time, population, current weather conditions, weather forecast, and professional sports teams.

In some implementations, content items may be obtained from resources that are not included in the content items data store 124. For example, recent news articles may not yet be indexed, so snippets of text from news articles on news websites may be obtained directly from those websites. In some implementations, the content items obtained may depend on the requesting user device 106. Given the example search query of “Atlanta,” if the requesting user device 106 is logged into a social network, the knowledge panel apparatus 110 may obtain content items related to the social network, such as identifying social contacts that are in some way associated with Atlanta. As another example, if a user searches for a particular restaurant, a content item eligible to be presented in a knowledge panel for that restaurant may specify that one or more of the user's social contacts has reviewed the restaurant.

The knowledge panel apparatus 110 ranks the content items 212 that are eligible to be presented in a knowledge panel. In some implementations, only a subset of the content items 212 is ranked. For example, a knowledge panel template may specify that a particular portion of the knowledge panel is reserved for a particular content item. The particular content item will automatically be selected for presentation, while a subset of the content items 212 will be ranked.

The content items 212 may be ranked based on many factors. For example, a search score for a content item may be used to rank the content item. The search score may, for example, be based on how often that content item is selected by a user in response to the content item being presented in a knowledge panel, or it may be based on how often a search result that references the resource that includes the content item is selected in response to a search for the entity that corresponds to the content item. Content items may also be ranked based on an authority score for the resource from which a content item was obtained, or an age score that indicates how old a content item is, or when it was last updated in the content items data store 124. Any suitable features or factors or combinations thereof may be used to rank content items 212, or to determine rank scores for content items 212.

The content items 212 are also ranked based, in part, on one or more topics of interest associated with the requesting user device 106. By way of example, the historical data 208 associated with the user device 106 may specify that a user of the device is interested in baseball, skiing, and travel. Accordingly, content items 212 that are related to baseball, skiing, and travel may have their rankings or rank scores increased as a result of their particular interest to the user of the requesting user device 106. For example, some content items 212 that correspond to Atlanta may be facts about upcoming events, such as theater performances, concerts, exhibitions, parades, sporting events, or trade shows. A content item that specifies an upcoming professional baseball game in Atlanta may have its rank score increased relative to the rank scores of upcoming events in Atlanta that are unrelated to the topics of interest for the requesting user device 106.

In some implementations, ranking content items based on a topic of interest includes ranking the content items based on one or more of the following: an interest score, a confidence score, and a resource score. The interest score indicates the strength of a user's interest in a topic of interest, and it is determined based on implicit user indications identified in the historical data. For example, a user may be interested in baseball, skiing, and travel, but may be more interested in one topic than another. Implicit user indications may be used to determine the strength of interest based on, for example, how often a user searches for a particular topic, how often a user visits websites or web pages related to the particular topic, or how often a user comments on micro-blog posts related to the particular topic. For example, a user that visits a baseball news website daily and a ski resort website twice in the past year may have a higher strength score for the baseball topic than the skiing topic.

The confidence score indicates a confidence that the user is interested in a particular topic, and it is determined based on explicit user indications identified in the historical data. For example, if a user has previously offered an explicit indication that the user is interested in a particular topic, the confidence score for that user maybe the highest possible confidence score, e.g., 1.0 on a 0.0 to 1.0 scale, where 1.0 is the highest confidence. Without an explicit user indication, the confidence score may be 0.0. In some implementations, the confidence score is also based on implicit user indications. For example, even without an explicit indication of interest, a search system may be able to generate a confidence score that measures the confidence that a user that visits a baseball news website daily is interested in baseball. As another example, the search system may be confident that a user who occasionally searches for vacation destinations has in interest in travel. Confidence scores for a topic may be calculated based on any suitable formula, and may take into account many factors, such as how often a user interacts with a resource related to a particular topic, what type of interaction occurred, and how a user's interactions compare to the interactions of other users that may or may not be interested in the particular topic.

A resource score indicates an importance of content included in a particular content item with respect to the resource from which the content item was obtained. For example, if a content item is an image, the importance score indicates how important that image is to the web page in which the image was included. For example, if an image is the only image on a web page, and it is located in the top-center of the page and occupies a large portion of the web page, the image may have a high importance score relative to an image that is one of many images on a web page, where the image is located near the bottom of a web page and occupies only a small portion of the web page. As another example, the importance score for a snippet of text may depend on its location in the resource from which is was taken, the size of the text relative to the size of other text included in the resource, and how the text relates, semantically, one or more topics associated with the resource from which it was taken.

Any suitable formula using the interest score, confidence score, resource score, and any combination thereof, may be used to rank a content item based on a particular topic of interest. For example, the scores may be summed and then multiplied by a rank score for a content item to determine a new rank score for the content item.

In some implementations, content items may also be ranked based on the format of the content item. For example, a user device may indicate a preference for content items in a particular format, such as a preference for text, audio, image, or video content items. A weather forecast, for example, can be presented in text, audio, image, or video format. If a user has indicated, explicitly or implicitly, a preference for audio content items, an audio content item that includes a weather forecast may have its rank score adjusted.

The knowledge panel apparatus 110 selects one or more content items 212 based on the rankings. In some implementations, the number and type of content items 212 selected is also based on the knowledge panel template 210. For example, a knowledge panel template 210 for a city may specify that one of the content items selected should be the highest ranking image associated with the city, one of the content items should specify the population of the city, three of the content items should specify the highest ranking facts associated with the city, two of the content items should specify two upcoming events that are about to occur, and space for up to five other content items may be reserved for the highest ranking content items that are not otherwise selected, such as news articles, locations of interest, or other facts not included in the three highest ranking facts. A content item that specifies an upcoming professional baseball game in Atlanta may have a lower rank score than several other upcoming event content items, but based on the requesting user device's interest in baseball, the rank score of the professional baseball game event may be increased such that it is selected as one of the top two ranking content items that specifies an upcoming event. In addition, a content item for Atlanta that specifies the city's professional baseball team may be selected as one of the top ranking facts, and one or more content items that specify locations of interest—related to travel—may also be selected.

Once content items 212 have been selected, the knowledge panel apparatus 110 provides the search system 108 with a knowledge panel 214 to provide in response to the search query 202. In some implementations, the search system 108 provides the knowledge panel 214 to the user device 206 along with search results 206 for the search query 202. In another implementation, the search system 108 provides only the knowledge panel 214 to the user device, without the search results 206.

In some implementations, the knowledge panel apparatus 110 determines that a proper subset of content included in a particular selected content item corresponds to the topic of interest. In the example data flow 200, if a snippet of text selected for a knowledge panel for the city of Atlanta states “Atlanta's professional baseball team is the Atlanta Braves,” the term, “baseball,” is a proper subset of that text that corresponds—e.g., matches—a topic of interest associated with the user device 106. In response to the determination, the knowledge panel apparatus 110 may cause the proper subset of the selected content item to be distinguished from other content included in that content item when the knowledge panel is presented. Using the example text above, the term, “baseball,” may be highlighted, or underlined, in order to distinguish the term from the remainder of the text. Distinguishing portions of content draws attention to the content item, and it may also serve as an indication to the user that the particular content item was selected for presentation in the knowledge panel based on that term corresponding to a topic of interest associated with that user's user device.

In some implementations, the knowledge panel apparatus 110 may include in the knowledge panel an indication that the knowledge panel has been customized based on topics of interest associated with the user device 106. For example, the bottom of the knowledge panel could include a snippet of text, such as “information bits shown based on your individual interests,” along with a link at which a user can review the user's topics of interest, and explicitly specify topics of interest.

In some implementations, the knowledge panel apparatus 110 may include in the knowledge panel a feedback element used to indicate or confirm or deny user interest in a topic or information format. For example, a customized knowledge panel may include a prompt, such as, “Some of the information provided is based on your interest in baseball. Are you interested in baseball?—Yes/No.” The “Yes” and “No” may be interactive objects that, upon interaction, record data indicating user interest in baseball, or lack thereof, in the historical data for the user device.

In some implementations, the search system 108 receives, from the user device, user input that indicates a selection of one of the content items that was presented in the knowledge panel 214. In response to the selection, the search system 108 may provide the user device 106 with data that causes the user device to obtain the resource from which the selected content item was obtained. For example, a knowledge panel for a person, such as Thomas Jefferson, may include a content item that specifies a book written by Thomas Jefferson. Selecting the content item may cause the user device to request the resource from which the information about Thomas Jefferson authoring the book was obtained. In some implementations, other resources may be provided in response to a content item selection, such as a search results page for the selected content item, or a shopping website where the item referenced in the selected content item may be purchased.

The foregoing description of the example data flow 200 is provided as an example implementation. The systems and methods described herein may be performed by other suitable configurations and operations. For example, the knowledge panel apparatus 110 and search system 108 may be included in the same system. Additional data stores may be used, and the data stores described in the example data flow 200 may be combined, where appropriate.

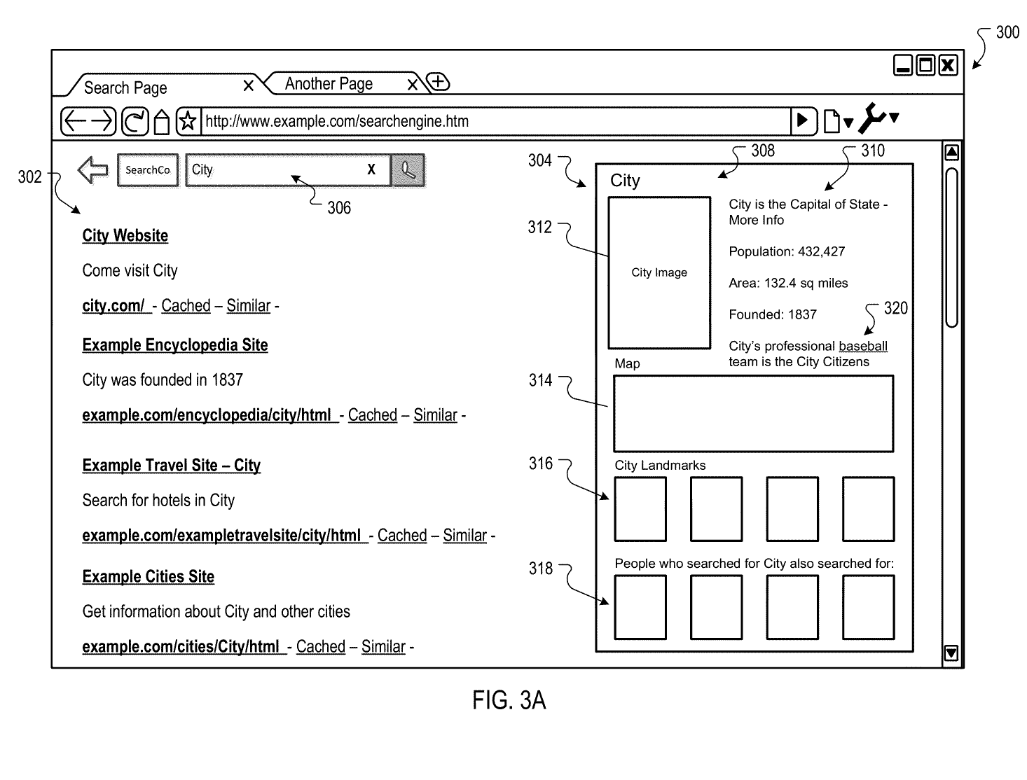

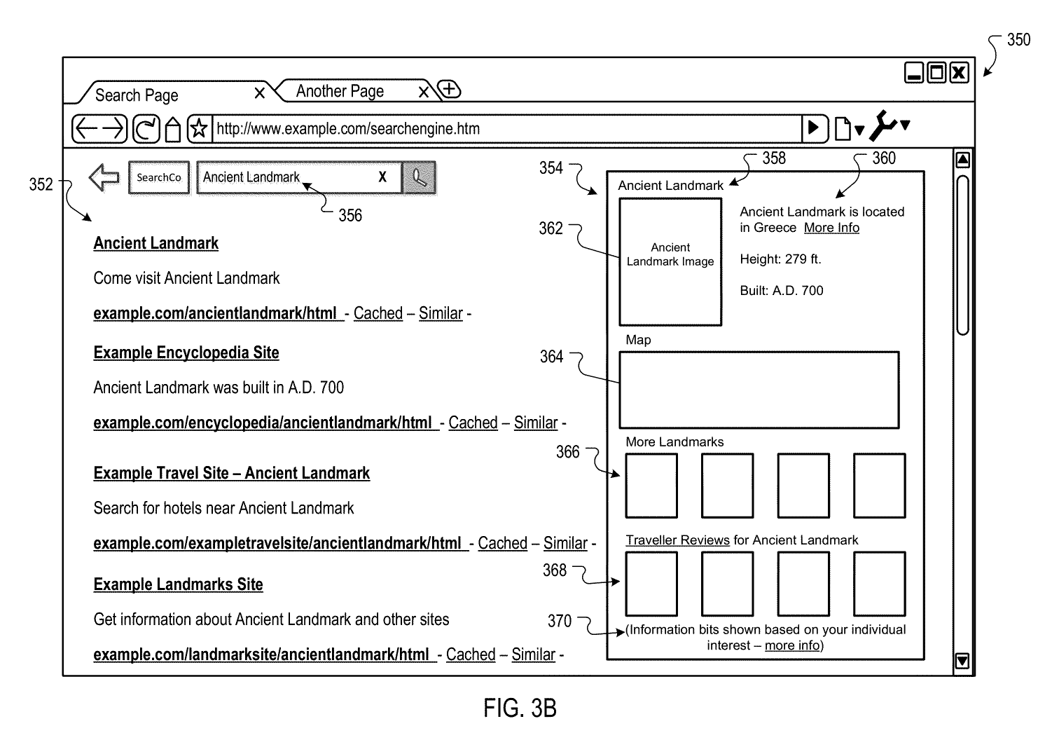

FIG. 3A is an example screen shot of a user interface 300 in which customized content is provided in a knowledge panel. The user interface 300 depicts a web browser of a user device, and the example page includes a list of search results 302 and a knowledge panel 304. The search results 302 and knowledge panel 304 are being presented in response to a search query 306 for a fictional city named “City.”

The example knowledge panel 304 includes a title 308 with the name of entity, “City,” a fact section 310 that includes snippets of text that include facts about the city, an image of the city 312, a map 314 of the city, images of city landmarks 316, and content items that depict other entities that are commonly searched by people who search for City 318. The example knowledge panel 304 also includes a snippet of text regarding the city's professional baseball team 320. In this example, the term, “baseball,” is underlined in snippet 320, which indicates that the snippet 320 was selected based on the requesting user device's interest in baseball.

FIG. 3B is another example screen shot of a user interface 350 in which customized content is provided in a knowledge panel. The user interface 350 depicts a web browser of a user device, and the example page includes a list of search results 352 and a knowledge panel 354. The search results 352 and knowledge panel 354 are being presented in response to a search query 356 for a fictional landmark called “Ancient Landmark.”

The example knowledge panel 354 includes a title 358 with the name of entity, “Ancient Landmark,” a fact section 360 that includes snippets of text that include facts about the landmark, an image of the landmark 362, a map 364 of the landmark's location, images of more landmarks 366, and content items that show reviews of user's who have visited the landmark 368. The example knowledge panel 354 also includes a notification 370 that indicates certain content items were selected based on the requesting user device's interests. For example, the “Traveller Reviews” section is underlined, because those content items were included in the knowledge panel based on the requesting user device's interest in travel.

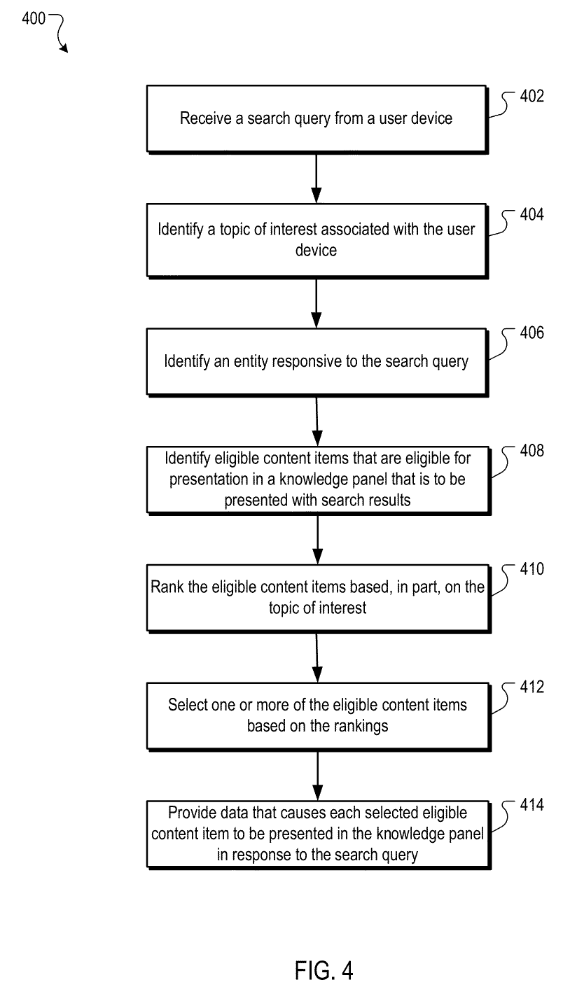

FIG. 4 is a flow diagram of an example process 400 for providing customized content in a knowledge panel. The process 400 may be implemented by a data processing apparatus, such as the search system, knowledge panel apparatus, or combination of the two described above.

A search query is received from a user device (402). For example, a user of a personal computer may use a web browser on the computer to send the search query.

A topic of interest associated with the user device is identified based on historical data describing user interactions for the user device (404). For example, a historical data store may include information that identifies several topics of interest that were previously specified as topics of interest by the user of the user device. In some implementations, the identified topic of interest is explicitly selected by the user as a topic of interest.

An entity responsive to the search query is identified (406). For example, an entity may be retrieved from an entity index that stores, for multiple entities, search queries that correspond to each entity. By way of another example, a semantic query parser may be used to identify an entity for the search query.

Eligible content items are identified that are eligible for presentation in a knowledge panel that is to be presented with the search results responsive to the search query (408). At least one eligible content item is obtained from a first resource, while at least one other eligible content item is obtained from a second resource. For example, content items may be obtained from a content item index that stores content items for entities. Each content item includes content obtained from a network resource, such as an image, text, or map.

The eligible content items are ranked based, in part, on the topic of interest (410). For example, the content items may have initial scores that indicate their relative importance with respect to their corresponding entity. Content items that are related to a topic of interest may have their initial scores modified, for example, increasing the initial score so that content items of interest are ranked higher than they would be if they were not related to a topic of interest.

In some implementations, the eligible content items are ranked by determining an interest score, a confidence score, and a resource score, and ranking the eligible content items based on the scores. The interest score may be determined based on implicit user indications identified in the historical data, and it indicates the strength of the user's interest in the topic of interest. The confidence score may be determined based on explicit user indications identified in the historical data, and it indicates a confidence that the user is interested in the identified topic of interest. The resource score is determined for each eligible content item, and it indicates an importance of the content included in the eligible content item with respect to the resource from which the content item was obtained.

One or more of the eligible content items are selected based on the rankings (412). For example, the top ranked content items may be selected for presentation in a knowledge panel.

Data that causes each selected eligible content item to be presented in the knowledge panel is provided to the user device in response to the query (414). For example, the user device may be provided with data that causes the knowledge panel to be displayed on the user device with the selected eligible content items.

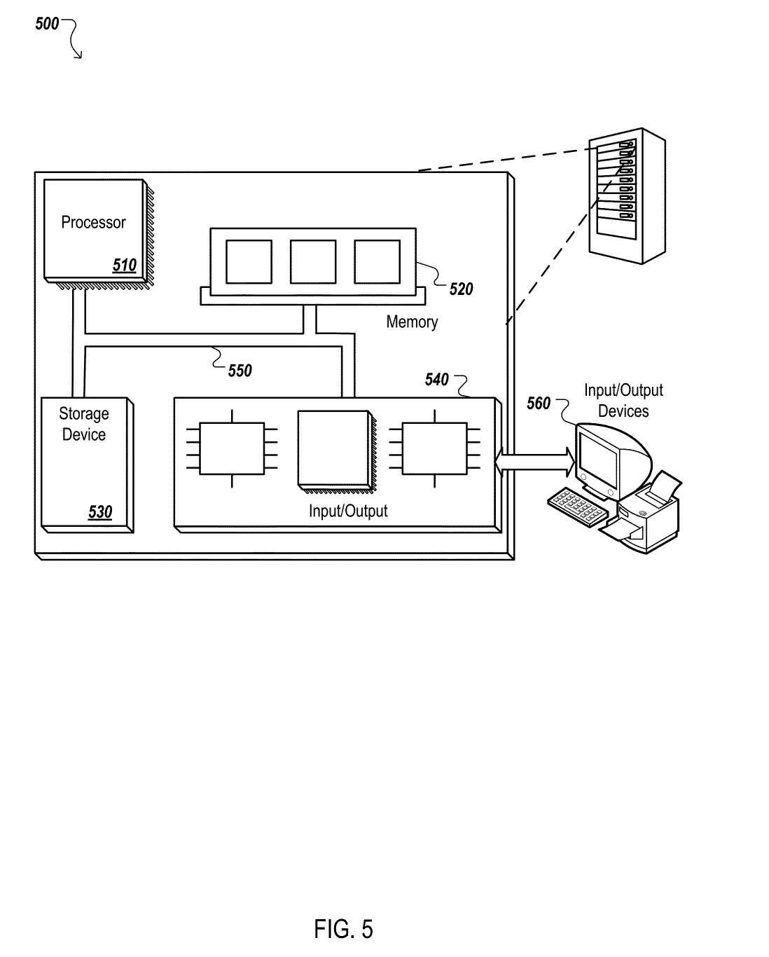

FIG. 5 is a block diagram 500 of an example data processing apparatus. The system 500 includes a processor 510, a memory 520, a storage device 530, and an input/output device 540. Each of the components 510, 520, 530, and 540 can, for example, be interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving input from a user device;
identifying, based on historical data describing user interactions for the user device, a topic of interest associated with a user of the user device;
identifying an entity responsive to the input;
identifying a plurality of eligible content items that are eligible for presentation in a knowledge panel that is to be presented with results responsive to the input, wherein at least one of the plurality of eligible content items is obtained from a first resource and at least one second of the plurality of eligible content items is obtained from a second resource;
ranking the eligible content items based, in part, on the topic of interest, the ranking including:
determining, based on implicit user indications identified in the historical data, an interest score that indicates a strength of the user's interest in the topic of interest relative to a strength of the user's interest in a different topic,
determining, for each eligible content item, a resource score that indicates an importance of content included in the eligible content item with respect to a resource from which the eligible content item was obtained, and
ranking the eligible content items based on the interest score and resource scores;
selecting one or more of the eligible content items based on the ranking; and
providing, to the user device, data that causes each selected eligible content item to be presented in the knowledge panel in response to the input.

2. The method of claim 1, wherein identifying a topic of interest associated with the user of the user device comprises identifying a topic of interest that is explicitly selected by the user as a topic of interest.

3. The method of claim 1, wherein ranking the eligible content items based, in part, on the topic of interest comprises:
determining, based on explicit user indications identified in the historical data, a confidence score that indicates a confidence that the user is interested in the identified topic of interest;
and
ranking the eligible content items comprises ranking the eligible content items based on the interest score, confidence score, and resource scores.

4. The method of claim 1, further comprising:
determining that a proper subset of content included in a particular selected eligible content item corresponds to the topic of interest, and wherein, in response to the determination, providing data that causes each selected eligible content item to be presented in the knowledge panel includes providing data that causes the proper subset of content to be distinguished from other content included in the particular selected eligible content item when presented in the knowledge panel.

5. The method of claim 1, further comprising:
receiving, from the user device, user input indicating selection of one of the content items presented in the knowledge panel, and in response:
providing, to the user device, data that causes presentation of a resource from which the selected content item was obtained.

6. The method of claim 1, wherein the input is a search query.

7. A system comprising:
a data processing apparatus; and
a data store storing instructions that, when executed by the data processing apparatus, cause the data processing apparatus to perform operations comprising:
receiving input from a user device;
identifying, based on historical data describing user interactions for the user device, a topic of interest associated with a user of the user device;
identifying an entity responsive to the input;
identifying a plurality of eligible content items that are eligible for presentation in a knowledge panel that is to be presented with results responsive to the input, wherein at least one of the plurality of eligible content items is obtained from a first resource and at least one second of the plurality of eligible content items is obtained from a second resource;
ranking the eligible content items based, in part, on the topic of interest, the ranking including:
determining, based on implicit user indications identified in the historical data, an interest score that indicates a strength of the user's interest in the topic of interest relative to a strength of the user's interest in a different topic,
determining, for each eligible content item, a resource score that indicates an importance of content included in the eligible content item with respect to a resource from which the eligible content item was obtained, and
ranking the eligible content items based on the interest score and resource scores;
selecting one or more of the eligible content items based on the ranking; and
providing, to the user device, data that causes each selected eligible content item to be presented in the knowledge panel in response to the input.

8. The system of claim 7, wherein identifying a topic of interest associated with the user of the user device comprises identifying a topic of interest that is explicitly selected by the user as a topic of interest.

9. The system of claim 7, wherein ranking the eligible content items based, in part, on the topic of interest comprises:
determining, based on explicit user indications identified in the historical data, a confidence score that indicates a confidence that the user is interested in the identified topic of interest;
and
ranking the eligible content items comprises ranking the eligible content items based on the interest score, confidence score, and resource scores.

10. The system of claim 7, wherein the operations further comprise:
determining that a proper subset of content included in a particular selected eligible content item corresponds to the topic of interest, and wherein, in response to the determination, providing data that causes each selected eligible content item to be presented in the knowledge panel includes providing data that causes the proper subset of content to be distinguished from other content included in the particular selected eligible content item when presented in the knowledge panel.

11. The system of claim 7, wherein the operations further comprise:
receiving, from the user device, user input indicating selection of one of the content items presented in the knowledge panel, and in response:
providing, to the user device, data that causes presentation of a resource from which the selected content item was obtained.

12. The system of claim 7, wherein the input is a search query.

13. A non-transitory computer readable medium storing instructions that, when executed by a data processing apparatus, cause the data processing apparatus to perform operations comprising:
receiving input from a user device;
identifying, based on historical data describing user interactions for the user device, a topic of interest associated with a user of the user device;
identifying an entity responsive to the input;
identifying a plurality of eligible content items that are eligible for presentation in a knowledge panel that is to be presented with results responsive to the input, wherein at least one of the plurality of eligible content items is obtained from a first resource and at least one second of the plurality of eligible content items is obtained from a second resource;
ranking the eligible content items based, in part, on the topic of interest, the ranking including:
determining, based on implicit user indications identified in the historical data, an interest score that indicates a strength of the user's interest in the topic of interest relative to a strength of the user's interest in a different topic,
determining, for each eligible content item, a resource score that indicates an importance of content included in the eligible content item with respect to a resource from which the eligible content item was obtained, and
ranking the eligible content items based on the interest score and resource scores;
selecting one or more of the eligible content items based on the ranking; and
providing, to the user device, data that causes each selected eligible content item to be presented in the knowledge panel in response to the input.

14. The non-transitory computer readable medium of claim 13, wherein identifying a topic of interest associated with the user of the user device comprises identifying a topic of interest that is explicitly selected by the user as a topic of interest.

15. The non-transitory computer readable medium of claim 13, wherein ranking the eligible content items based, in part, on the topic of interest comprises:
determining, based on explicit user indications identified in the historical data, a confidence score that indicates a confidence that the user is interested in the identified topic of interest;
and
ranking the eligible content items comprises ranking the eligible content items based on the interest score, confidence score, and resource scores.

16. The non-transitory computer readable medium of claim 13, wherein the operations further comprise:
determining that a proper subset of content included in a particular selected eligible content item corresponds to the topic of interest, and wherein, in response to the determination, providing data that causes each selected eligible content item to be presented in the knowledge panel includes providing data that causes the proper subset of content to be distinguished from other content included in the particular selected eligible content item when presented in the knowledge panel.

17. The non-transitory computer readable medium of claim 13, wherein the operations further comprise:
receiving, from the user device, user input indicating selection of one of the content items presented in the knowledge panel, and in response:
providing, to the user device, data that causes presentation of a resource from which the selected content item was obtained.

18. The non-transitory computer readable medium of claim 13, wherein the input is a search query.
